(19) United States
(12) Patent Application Publication
(10) Pub. No.: US 2017/0116651 A1
(43) Pub. Date: Apr. 27, 2017

(54) METHOD AND SYSTEM FOR LOCATION TRACKING IN ABSENCE OF NETWORK CONNECTIVITY

(71) Applicant: International Business Machines Corporation, Armonk, NY (US)

(72) Inventor: Jeremy A. Greenberger, Raleigh, NC (US)

(21) Appl. No.: 14/922,519

(22) Filed: Oct. 26, 2015

(51) Int. Cl. G06Q 30/02; G06F 17/30; H04W 40/24; H04W 4/02; H04L 12/26

(52) U.S. Cl. CPC G06Q 30/0281; H04W 4/022; H04L 43/0894; H04W 40/246; G06F 17/30241; G06Q 30/0261

(57) ABSTRACT

Disclosed embodiments provide an approach for location tracking during an absence of network connectivity. Furthermore, embodiments enable interactive location-based alert messages and/or coupons to be rendered while a device is in an offline mode. A geofence is established for downloading venue data prior to entering a venue. If network connectivity is lost while in the venue, local position information is stored on the mobile device. When network connectivity is reestablished, the stored local position information is uploaded to a data server.

### FIELD OF THE INVENTION

The present invention relates generally to location tracking and, more particularly, to a method and system for location tracking in absence of network connectivity.

### BACKGROUND

Modern retail establishments often include multiple departments such as groceries, home goods, shoes, and jewelry, to name a few. As mobile device technology progresses and is widely adopted, customers want an interactive shopping experience in a physical “brick-and-mortar” retail establishment that is comparable to an online shopping experience. Customers can use their mobile devices such as cell phones, tablet computers, and/or wearable technology as part of a retail shopping experience. As more and more consumers obtain such mobile devices, it is desirable to have improvements in interactive retail shopping experiences.

### SUMMARY

In a first aspect, embodiments provide a computer-implemented method for tracking location of a mobile device in a venue, comprising: downloading venue data to the mobile device upon entering a geofence region in a perimeter around the venue; obtaining local position data of the mobile device within the venue; determining whether the mobile device is in a condition of network unavailability; and responsive to determining the condition of network unavailability, storing the local position data to the mobile device during the condition of network unavailability.

In a second aspect, embodiments provide a computer-implemented method for tracking location of a mobile device in a venue, comprising: downloading venue data to the mobile device upon entering a geofence region in a perimeter around the venue; obtaining local position data upon entering the venue; determining a condition of network unavailability; storing the local position data to the mobile device during the condition of network unavailability; detecting a reestablishment of network availability; transmitting the local position data to a data server; and caching the venue data in the mobile device.

In a third aspect, embodiments provide a mobile device comprising: a processor; a memory coupled to the processor; a network interface coupled to the processor; a local receiver coupled to the processor; a geolocation receiver coupled to the processor, wherein the memory contains instructions, which when executed by the processor, perform the steps of: downloading venue data to the mobile device upon entering a geofence region in a perimeter around the venue; obtaining local position data upon entering the venue; determining a condition of network unavailability; and storing the local position data to the mobile device during the condition of network unavailability.

### BRIEF DESCRIPTION OF THE DRAWINGS

Features of this invention will be more readily understood from the following detailed description of the various aspects of the invention taken in conjunction with the accompanying drawings. The drawings may not be to scale.

FIG. 1 shows an exemplary venue.

FIG. 2 is a block diagram of a system in accordance with embodiments of the present invention.

FIG. 3 is a block diagram of a mobile device used in embodiments of the present invention.

FIG. 4 shows an exemplary venue with network unavailability zones.

FIG. 5 shows an exemplary default geofence.

FIG. 6 shows an exemplary resized geofence.

FIG. 7 shows an example of downloaded venue data.

FIG. 8 shows an example of uploaded location data.

FIG. 9 is a flowchart indicating process steps for embodiments of the present invention.

### DETAILED DESCRIPTION

Example embodiments will now be described more fully herein with reference to the accompanying drawings, in which example embodiments are shown. This disclosure may, however, be embodied in many different forms and should not be construed as limited to the example embodiments set forth herein. Rather, these example embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

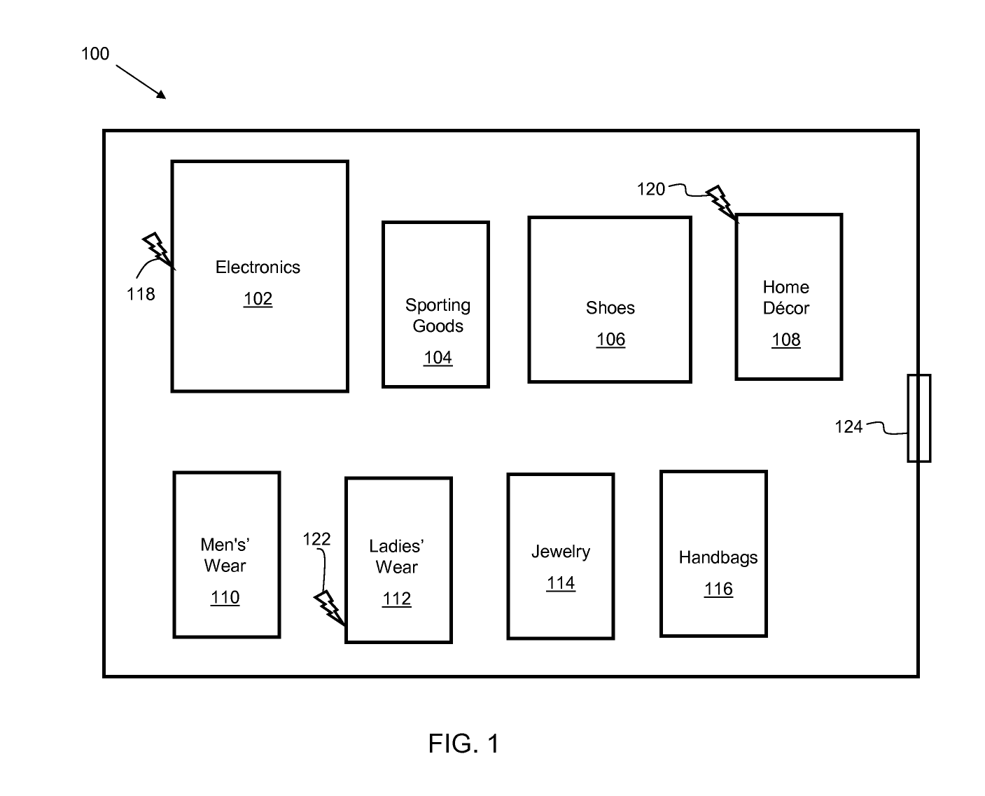

FIG. 1 shows an exemplary venue 100. Typically, the venue is an indoor venue such as a retail establishment. Venue 100 is a department store including various departments indicated by reference numbers 102-116. An Indoor Positioning System (IPS) allows a mobile device to determine its position within the venue. In embodiments, multiple wireless transmitters 118, 120, and 122 are positioned within venue 100. The wireless transmitters may be RF beacons, WiFi transmitters, Bluetooth® transmitters, or other suitable protocol. When a user enters the store at entrance 124, their mobile device makes a location assessment within the venue by use of the wireless transmitters. The location assessment may be accomplished by triangulation, beacon proximity, or other suitable location determination technique. In some embodiments, triangulation may occur using transmitters that are located outside of the venue. For example, in some embodiments, triangulation may occur using local radio station transmitters that are within range of the venue, such as local FM or AM radio stations. Embodiments may include assessing signal strength and additionally performing a station identification using frequency and/or an SSID (service set identifier) or other identifier to make a location assessment. In some embodiments, an inertial navigation system may be used to determine location within the venue 100. In some embodiments, an optical system may be used to determine location within the venue 100. Thus, in some embodiments, a location assessment may be made without the use of transmitters. Regardless of how the location determination is made, it is desirable for retailers to know the habits and preferences of their customers. For example, it may be desirable to know that a particular customer visited Ladies' Wear 112, followed by Handbags 116, followed by Shoes 106. By understanding the habits and preferences of individual customers, custom-tailored messages and coupons can be offered to those customers that are likely to be relevant for them. Note that while venue 100 is a retail establishment, embodiments of the present invention may be utilized in other venues such as hospitals, airports, train stations, and office buildings, to name a few. While typically the venue may be an indoor venue, embodiments may also include venues that are outdoors, or partially outdoors, such as a hotel resort.

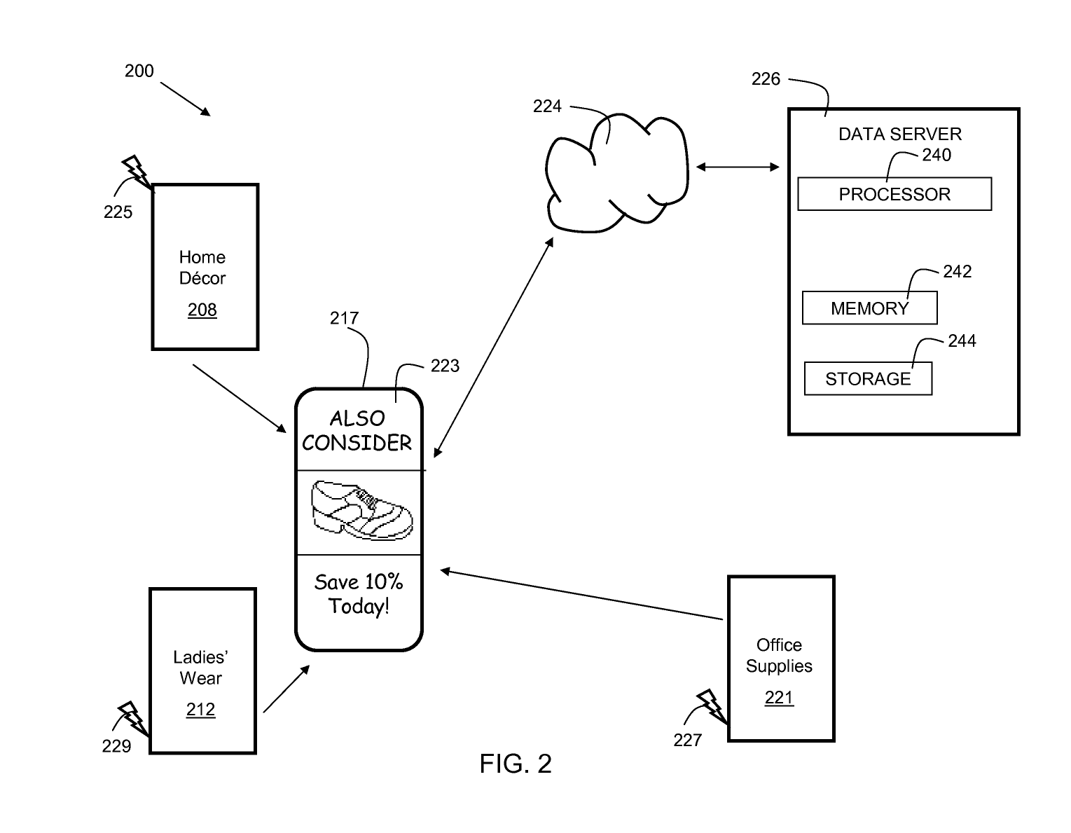

FIG. 2 is a block diagram 200 of a system in accordance with embodiments of the present invention. A user brings a mobile device 217 into a venue where it receives wireless signals from transmitters 225, 227, and 229 to make a location determination. The location determination may be a zone-based determination. For example, it may be sufficient to know that the user is in the Ladies' Wear department 212, Home Décor department 208, or Office Supplies department 221. It may not be necessary to resolve the location to a precise location beyond that zone determination. The mobile device 217 communicates via network 224 to a data server 226. The data server 226 may include a processor 240, memory 242, and storage 244. The processor 240 is coupled to the memory 242 such that it can access instructions stored in memory 242. The processor 240 executes the instructions in implementation of embodiments of the present invention. The storage 244 may include one or more hard disks, or other suitable storage technology. Note that while one data server is illustrated in diagram 200, in practice, there may be multiple data servers 226 operating in a distributed manner for load balancing and data redundancy. In embodiments, data servers 226 may implement an object store system utilizing a cloud-based architecture.

The mobile device 217 transmits location information via network 224 to the data server 226. The location information may include a zone, and a user identifier. For example, the zone may indicate the user is in the Ladies' Wear department 212. The data server 226 may maintain a customer profile and have preferences stored for the customer, which indicates that the customer also tends to visit the shoe department when they visit the venue. The data server 226 can in response serve a shoe department coupon and/or alert message 223 to the user's mobile device 217. This can be performed using customized applications (“apps”) running on the mobile device. In embodiments, users install the app, and opt-in to provide their location information in exchange for coupons, discounts, and other product-related information. Thus, a more interactive shopping experience is achieved. In some embodiments, the location information may further include path information, such that the path the user took within the venue is included as part of the location information.

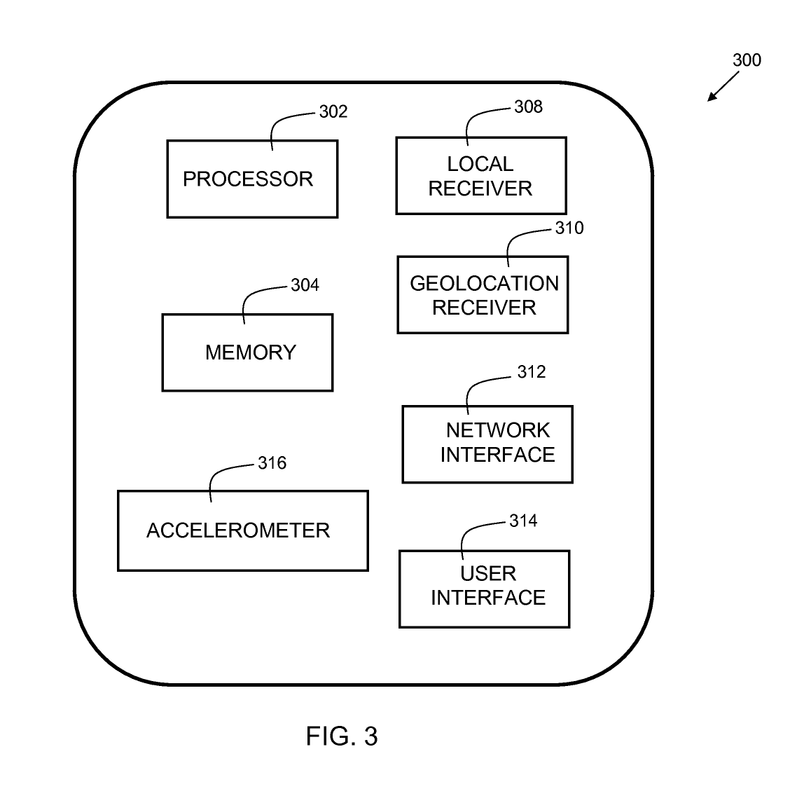

FIG. 3 is a block diagram of a mobile device 300 used in embodiments of the present invention. The mobile device 300 includes a processor 302 which is coupled to memory 304. Memory 304 contains instructions, that when executed by the processor 302, perform the various methods in accordance with illustrative embodiments. Mobile device 300 may further include a local receiver 308. The local receiver 308 includes a receiver for local radio frequency (RF) signals. In embodiments, the local receiver may include a Bluetooth® receiver, ZigBee® receiver, or other near field communication (NFC) receiver. Mobile device 300 further may include a geolocation receiver 310. The geolocation receiver may be configured to receive signals from multiple satellites to triangulate a position on Earth. In embodiments, the geolocation receiver 310 includes a Global Positioning System (GPS) receiver, GLONASS receiver, Galileo receiver, or other satellite-based positioning system. The mobile device 300 further includes a network interface 312. Network interface 312 may include a cellular network interface, a WiFi interface, such as an IEEE 802.11 interface, or other suitable network interface. Mobile device 300 may further include a user interface 314. User interface 314 may include a touchscreen, and provides a user with the ability to enter information as necessary to utilize embodiments of the present invention. The mobile device 300 may further include an accelerometer 316 which may be used to detect motion of the mobile device, and may serve in the role of location assessment using inertial navigation techniques. In some embodiments, mobile device 300 may be a smart phone or tablet computer.

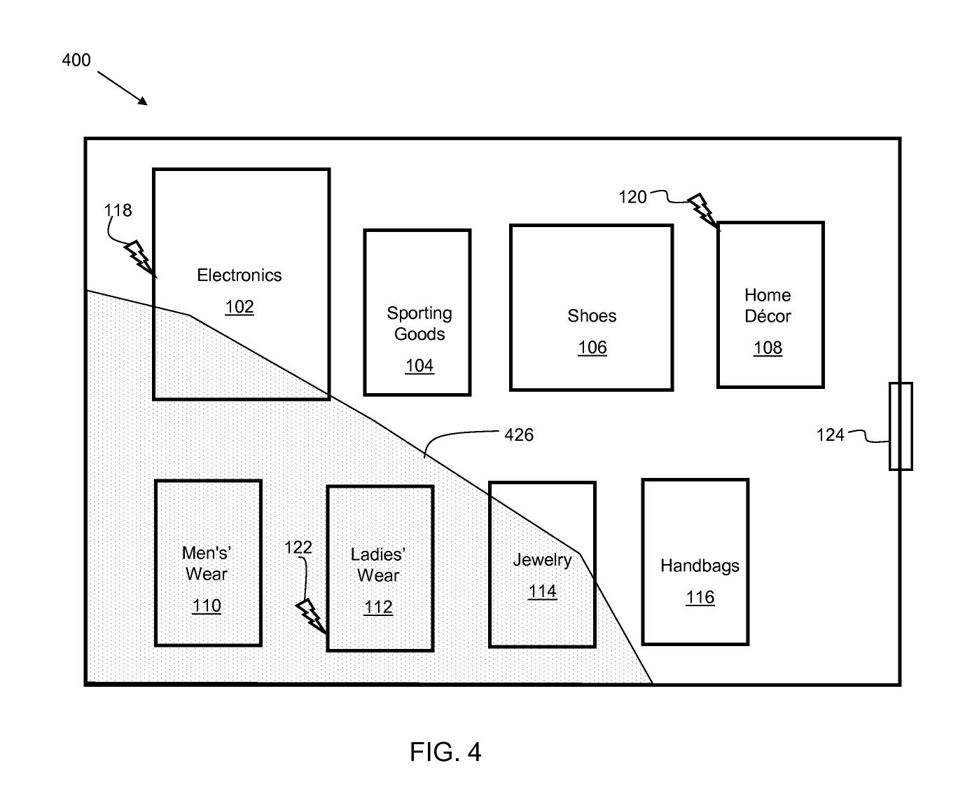

FIG. 4 shows an exemplary venue 400 with network unavailability zones. In ideal conditions, the mobile device has full network connectivity to the data server (226 of FIG. 2) while in the venue. In practice, part, or all, of the venue may have no cellular service, and thus no network connectivity to the data server. In the absence of network connectivity, the mobile device is said to be in “offline mode,” meaning a condition of network unavailability. This is especially the case for underground venues such as a train station or underground shopping venue. For example, venue 400 has dark area 426 indicating no cellular service. As can be seen, the dark area 426 includes the entirety of the Men's Wear department 110 and Ladies' Wear department 112. Additionally, the dark area includes a portion of the Electronics department 102 and the Jewelry department 114. Thus, when a customer moves from the Sporting Goods department 104 to the Ladies' Wear department 112, the data server (226 of FIG. 2) is not able to be notified at that time, since there is no network connectivity in the Ladies' Wear department 112. This can inhibit the interactive shopping experience. Embodiments of the present invention address this problem by providing a geofence around the venue. When the user (with their mobile device) enters the geofence, venue data such as floor plans, transmitter locations, alert messages, and coupons, are downloaded to the mobile device. Then, when in the venue, if network connectivity is lost, the location information obtained from the indoor positioning system is saved to the mobile device. When network connectivity is restored, the saved location data is uploaded to the data server.

Additionally, location-based alert messages and/or location-based coupons can be activated and presented to the user, even during times of no network connectivity. For example, upon entering the geofence, the mobile device can download a coupon that is to be presented upon entering the Ladies' Wear department 112. Since the Ladies' Wear department 112 is within dark area 426, the mobile device cannot communicate with the data server upon entering the Ladies' Wear department 112. However, the mobile device can render the coupon that is downloaded a priori and stored on the mobile device. When the mobile device regains network connectivity, the mobile device can upload location data to the data server.

In some embodiments the storing of the local position data to the mobile device during the condition of network unavailability occurs when a location duration exceeds a predetermined dwell threshold. For example, a predetermined dwell threshold of 15 seconds may be established. In this case, if the user is in a particular zone for 15 seconds or more, the location information is recorded to the mobile device. If the user is in a particular zone for less than 15 seconds, the location information is not recorded to the mobile device. In this way, storage space on the mobile device is not consumed for cases where the user simply passed through a zone quickly. For example, if a user walked from the Men's Wear department 110 to the Jewelry department 114 by quickly passing through the Ladies' Wear department 112, then the user location in the Ladies' Wear department is not recorded as long as the time spent in the Ladies' Wear department is less than the predetermined dwell threshold.

In embodiments, the predetermined dwell threshold may be included as part of the downloaded venue data. In embodiments, the location or zone is stored on the mobile device along with a time value. In embodiments, the time value may be stored in seconds. If the mobile device receives an additional radio signal indicating the user is still in the same zone or general area, the time value may be incremented to reflect additional time spent in that zone. For example, if the user spends 10 minutes in the Men's Wear department 110, the mobile device may receive 145 pings from transmitter 122, during that time. Rather than store each ping separately and transmit that information to the data server separately, embodiments may compress the data into a single location event and a corresponding duration by incrementing the time spent in that zone, instead of storing a separate transmitter ping for each ping received. Thus, the mobile device can collapse all the pings from the transmitter to a zone level, and merely send a single location report for the Men's Wear department indicating that the user spent 10 minutes there. In this way, memory usage on the mobile device and network traffic is reduced.

Note that while embodiments utilize a local positioning system referred to as an Indoor Positioning System (IPS), it will be recognized that embodiments may use such a system outdoors. In particular, in scenarios where a satellite-based signal is difficult to receive, such as in cities with tall skyscrapers, mountainous areas, or areas of thick forest, such an Indoor Positioning System (IPS) may be utilized. Thus, embodiments of the present invention are not limited to indoor use.

The location data may include, but is not limited to, which zones were visited, a network unavailability zone status (indicating which zones do not have network connectivity), a list of alert messages rendered while in offline mode, a list of coupons rendered while in offline mode, and a user identifier to indicate which user is reporting this information. In embodiments, the user identifier may be a mobile telephone number, e-mail address, or other suitable identifier. In this way, the user continues to have an interactive retail experience, even in the absence of network connectivity. Once the location data is uploaded to the data server, the location data may be deleted from the mobile device to free up device memory (storage). That is, some embodiments include removing the local position data from the mobile device after the transmitting of the local position data to the data server. In some embodiments, downloaded venue data may be cached to the mobile device. In some embodiments, the downloaded venue data has a version associated with it. Some embodiments include comparing a cached venue data version with a server venue data version on the data server, and only downloading the venue data when the cached venue data version does not match the server venue data version. For example, suppose a user visits a particular retail establishment a few times per week. The venue information can be stored on the mobile device so that it doesn't need to be downloaded each time the user enters the geofence. If a version check determines that updated venue information is available, then in that case, the updated venue information is downloaded to the mobile device.

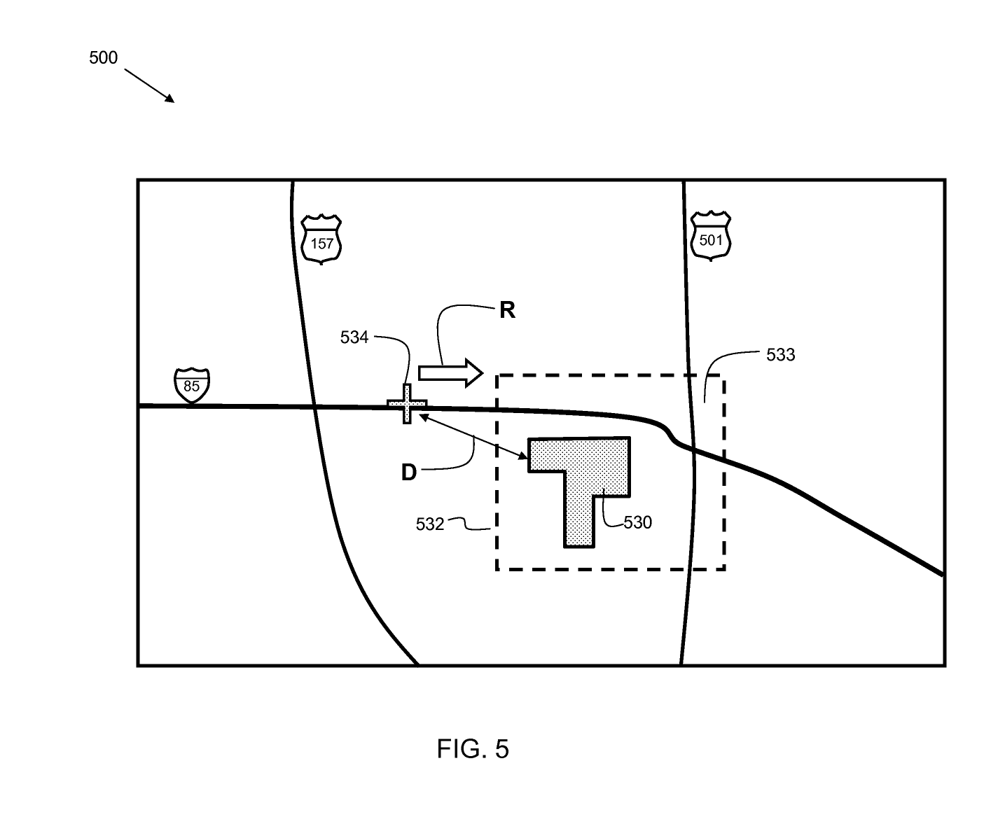

FIG. 5 shows a map 500 illustrating an exemplary default geofence. Map 500 includes a retail venue 530. A user 534 is travelling along a road in the direction indicated by arrow R toward the venue 530. As depicted, the user 534 is at a distance D from the venue 530. A geofence is established in the user's mobile device. The geofence may include a plurality of latitude-longitude coordinates to establish a closed shape with a perimeter 532 that defines a geofence region 533. The geolocation receiver (310 of FIG. 3) determines when the user has entered the geofence region 533 and the mobile device of the user 534 downloads the venue data in response to the entering of the geofence region. As depicted in FIG. 5, the user 534 is currently outside of the geofence region 533, and thus the venue data has not yet begun to download. Once the user 534 enters the geofence region 533, the venue data begins to download to the user's mobile device. In embodiments, the geofence may be a region on the order of a few square miles in area, such that within a few miles of the venue, the venue data is downloaded to the mobile device while the user is still outdoors, and thus likely has strong network connectivity. In embodiments, the geofence may be established as a part of an install process when executing a custom application for the first time. In some embodiments, the geofence may be established by the venue. In other embodiments, the geofence may be established by users of the mobile device. For example, upon running an application on a mobile device for the first time, a user may be asked to identify their preferred venue location. Once they enter their preferred venue location, a geofence for that location is downloaded to their mobile device and stored on the mobile device.

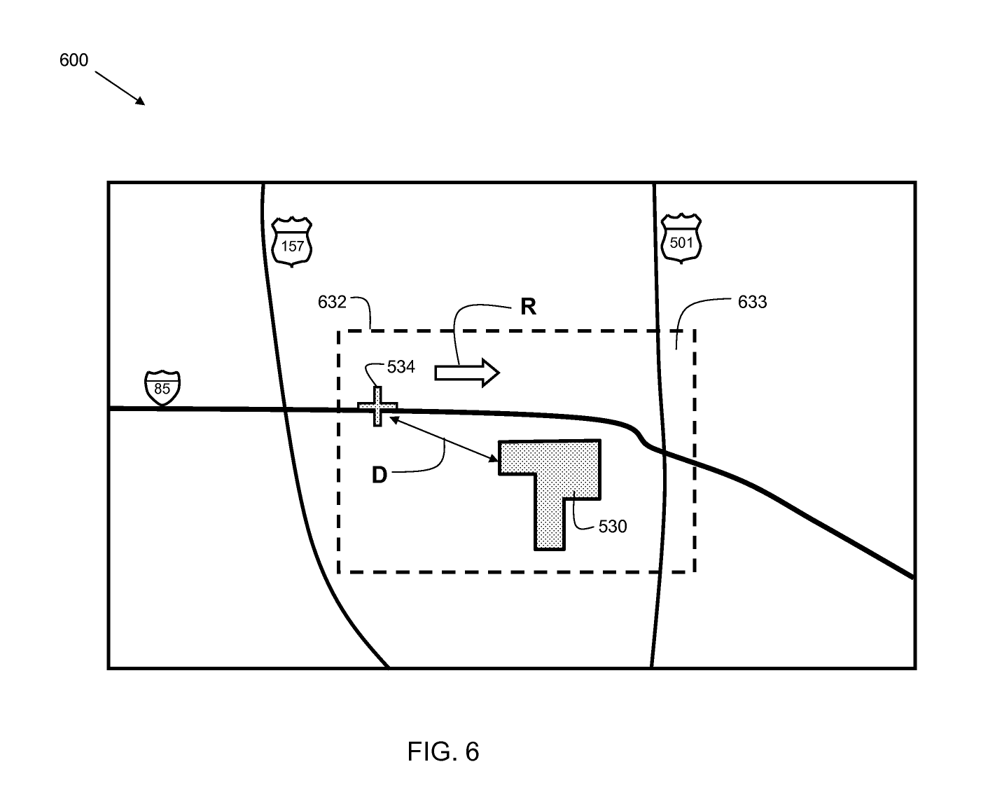

FIG. 6 shows a map 600 illustrating an exemplary resized geofence. In some embodiments, the mobile device may periodically or continuously perform a network bandwidth assessment. If the current network bandwidth falls below a predetermined threshold, then the geofence can be resized in response to the network conditions. For example, if the user happens to be streaming video at the time they are travelling to venue 530, the available bandwidth may be reduced. In response to a reduction in network bandwidth, a resized geofence 632 having an enlarged geofence region 633 can be established. In embodiments, the processor on the mobile device may perform the resizing. The resized geofence 632 results in the user 534 downloading venue data earlier, when they are further away from the venue (as compared with geofence 532 of FIG. 5). This allows more time to download the venue data. The venue data can be downloaded at a reduced rate, to accommodate other activities such as media streaming, or other network conditions. In this way, the user can still complete the venue download prior to entering the venue 530. In some embodiments, the resized geofence 632 is twice the size of the default geofence 532 shown in FIG. 5. Note that while the geofences illustrated in FIG. 5 and FIG. 6 are rectangular, other shapes such as circles, complex polygons, or other custom-defined shapes are possible. In embodiments, the geofences may be designed to accommodate the path of roads and/or other geographic features.

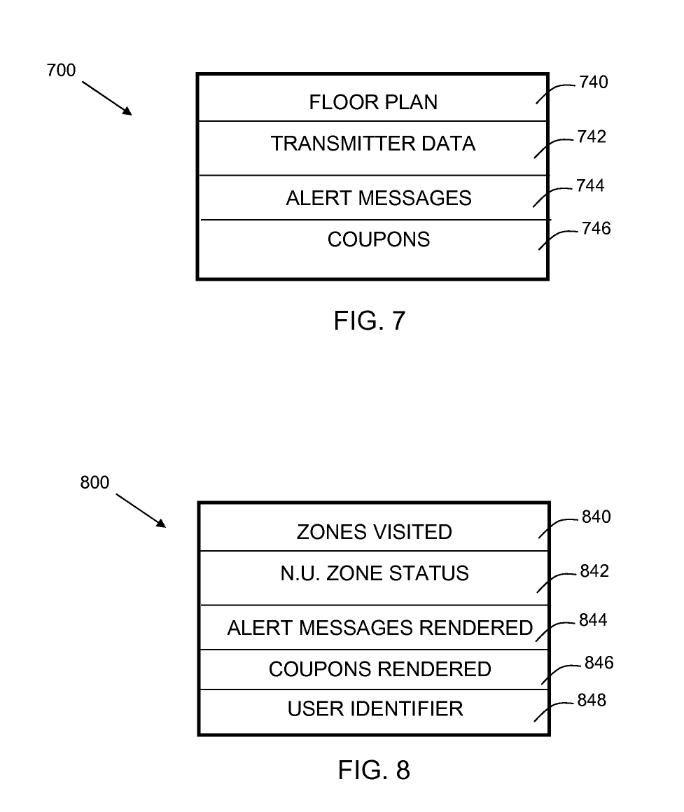

FIG. 7 shows an example of downloaded venue data 700. This is data that is downloaded upon entering a geofence region. The downloaded venue data may include, but is not limited to, a floor plan 740 for the venue, transmitter data 742 within the venue, location-based alert messages 744, and location-based coupons 746. The transmitter data 742 may include, but is not limited to, transmitter radio frequencies, transmitter locations within the venue, zones or departments associated with each transmitter, and/or SSID values.

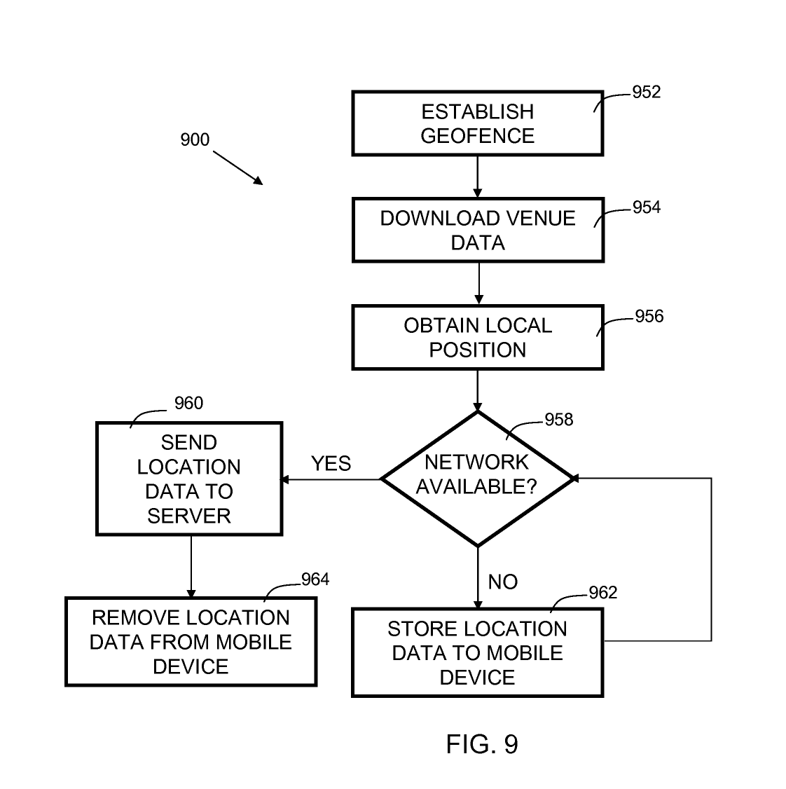

FIG. 8 shows an example of uploaded location data 800. This is data that is uploaded to the data server after network connectivity is reestablished, as discussed with reference to FIG. 9 below. The uploaded location data may include, but is not limited to, zones visited 840 for the venue, network unavailability (N. U.) zone status 842 for the venue, alert messages rendered 844 while in offline mode, coupons rendered 846 while in offline mode, and a user identifier 848. The network unavailability zone status 842 can be useful for retailers to understand the network connectivity situation in their establishments. For example, a retailer may not be aware that they have a network connectivity issue in a particular department. Possessing this infrastructure information is of value to a retailer and allows them to take a corrective action, such as installing additional signal amplifiers to boost signal in those areas.

FIG. 9 is a flowchart 900 indicating process steps for embodiments of the present invention. In process step 952, a geofence is established. In process step 954, venue data is downloaded to the mobile device. In process step 956 local position information is obtained from the Indoor Positioning System. In process step 958, a check is made to determine if network connectivity is available. If yes, then the location data is sent to the data server (226 of FIG. 2). If no, then the location data received from the Indoor Positioning System is stored to the mobile device. The mobile device periodically checks network connectivity again at step 958. If the mobile device detects a reestablishment of network availability, the location data stored in process step 962 is sent to the data server in process step 960. After the location data is sent to the data server in process step 960, the location data may be removed from the mobile device in process step 964.

The mobile device 300 shown in FIG. 3 and the data server shown in FIG. 2 may be described in the general context of computer-executable instructions, such as program modules, being executed by a computer. Generally, program modules include routines, programs, components, logic, data structures, and so on, which perform particular tasks or implement particular abstract data types. Disclosed embodiments may be practiced in distributed computing environments where tasks are performed by remote processing devices that are linked through a communications network. In a distributed computing environment, program modules may be located in both local and remote computer storage media including memory storage devices.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

Embodiments of the present invention may also include a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Disclosed embodiments provide an approach for location tracking during an absence of network connectivity. Furthermore, embodiments enable interactive location-based alert messages and/or coupons to be rendered while a device is in an offline mode. A geofence is established for downloading venue data prior to entering a venue. If network connectivity is lost while in the venue, local position information is stored on the mobile device. When network connectivity is reestablished, the stored local position information is uploaded to a data server. Thus, an improved customer experience is achieved while in the venue, and improved reporting is provided to venue operators.

What is claimed is:

1. A computer-implemented method for tracking location of a mobile device in a venue, comprising:
downloading venue data to the mobile device upon entering a geofence region in a perimeter around the venue;
obtaining local position data of the mobile device within the venue;
determining whether the mobile device is in a condition of network unavailability; and
responsive to determining the condition of network unavailability, storing the local position data to the mobile device during the condition of network unavailability.

2. The method of claim 1, further comprising:
detecting a reestablishment of network availability; and
transmitting the local position data to a data server.

3. The method of claim 2, further comprising removing the local position data from the mobile device after the transmitting of the local position data to the data server.

4. The method of claim 1, wherein venue data includes transmitter data for a plurality of transmitters.

5. The method of claim 1, wherein the venue data further includes location-based alert messages.

6. The method of claim 1, wherein the storing of the local position data to the mobile device during the condition of network unavailability occurs when a location duration exceeds a predetermined dwell threshold.

7. The method of claim 6, wherein the storing of the local position data to the mobile device further includes recording a time spent in a zone.

8. The method of claim 1, further comprising:
performing a network bandwidth assessment; and
resizing the geofence based on results of the network bandwidth assessment.

9. The method of claim 2, further comprising transmitting network unavailability zone data to the data server.

10. A computer-implemented method for tracking location of a mobile device in a venue, comprising:
downloading venue data to the mobile device upon entering a geofence region in a perimeter around the venue;
obtaining local position data upon entering the venue;
determining a condition of network unavailability;
storing the local position data to the mobile device during the condition of network unavailability;
detecting a reestablishment of network availability;
transmitting the local position data to a data server; and
caching the venue data in the mobile device.

11. The method of claim 10, further comprising:
comparing a cached venue data version with a server venue data version on the data server; and
only downloading the venue data when the cached venue data version does not match the server venue data version.

12. A mobile device comprising:
a processor;
a memory coupled to the processor;
a network interface coupled to the processor;
a local receiver coupled to the processor;
a geolocation receiver coupled to the processor; wherein the memory contains instructions, which when executed by the processor, perform the steps of:
downloading venue data to the mobile device upon entering a geofence region in a perimeter around the venue;
obtaining local position data upon entering the venue;
determining a condition of network unavailability; and
storing the local position data to the mobile device during the condition of network unavailability.

13. The mobile device of claim 12, wherein the memory further comprises instructions, which when executed by the processor, perform steps of:
detecting a reestablishment of network availability; and
transmitting the local position data to a data server.

14. The mobile device of claim 13, wherein the memory further comprises instructions, which when executed by the processor, perform steps of:
removing the local position data from the mobile device after the transmitting of the local position data to the data server.

15. The mobile device of claim 12, wherein the memory further comprises instructions, which when executed by the processor, perform steps of receiving venue data that includes transmitter data for a plurality of transmitters.

16. The mobile device of claim 12, wherein the memory further comprises instructions, which when executed by the processor, perform steps of receiving venue data that includes a plurality of location-based alert messages.

17. The mobile device of claim 12, wherein the memory further comprises instructions, which when executed by the processor, perform steps of receiving venue data that includes a plurality of location-based coupons.

18. The mobile device of claim 12, wherein the memory further comprises instructions, which when executed by the processor, performs steps of storing the local position data to the mobile device during the condition of network unavailability when a location duration exceeds a predetermined dwell threshold.

19. The mobile device of claim 12, wherein the memory further comprises instructions, which when executed by the processor, perform steps of:
performing a network bandwidth assessment; and
resizing the geofence based on results of the network bandwidth assessment.

20. The mobile device of claim 13, wherein the memory further comprises instructions, which when executed by the processor, perform steps of transmitting network unavailability zone data to the data server.
